(19) United States
(12) Patent Application Publication
(10) Pub. No.: US 2016/0023925 A1
(43) Pub. Date: Jan. 28, 2016

(54) POLARIZED ELECTRODIALYSIS

(71) Applicant: WISEWATER PTE. LTD, Singapore (SG)

(72) Inventor: Haobing LIU, Singapore (SG)

(73) Assignee: WISEWATER PTE. LTD., Singapore (SG)

(21) Appl. No.: 14/775,675

(22) PCT Filed: Mar. 14, 2014
(86) PCT No.: PCT/SG2014/000124

§ 371 Date: Sep. 12, 2015

Related U.S. Application Data
(60) Provisional application No. 61/783,881, filed on Mar. 14, 2013.

(51) Int. Cl. C02F 1/469

(52) U.S. Cl. CPC C02F 1/4693; C02F 2201/46

(57) ABSTRACT

Some embodiments described herein generally relate to apparatus and methods for performing polarized electrodialysis, which may be used for desalination, purification and concentration. Such apparatus may include, for example, a pair of electrodes, a plurality of ion exchange membranes disposed between the pair of electrodes and a reservoir between each of the electrodes and the ion exchange membranes. The ion exchange membranes may include cation exchange membranes alternating with anion exchange membranes. A voltage may be applied between the pair of electrodes to generate concentration polarization wherein concentration of ions near the surface of one of at least one of the cation and anion exchange membranes is lower than a concentration of ions in the sample solution. The solution with lower ion concentration may be collected to form a desalinated stream by the apparatus. The apparatus and methods may also be able to remove or concentrate less mobile, weakly charged or bigger matters which cannot be purified by conventional electrodialysis.

### CROSS-REFERENCE

This patent application claims the benefit of U.S. Provisional Application No. 61/783,881 filed on Mar. 14, 2013, which provisional application is incorporated herein by specific reference in its entirety.

### BACKGROUND

Growing global population, environmental change, and vast pollution of water sources due to industrialization have caused it a severe challenge to provide enough fresh and clean water for people. In the past century, water purification methods which belong to categories such as distillation, filtration, chemistry, and electrochemistry have been essentially improved and invented, to recover fresh and purified water from sources such as sea, surface water, ground water, and even wastewater, for the residential, agricultural and industrial consumptions. However, the state of the art technologies are still far from perfect in terms of initial cost, maintenance cost, and power consumption. In addition, each technology has its limited cost-effective applications and its suitable source water range. It is important to keep improving the existing technologies and develop new ones, to reduce material and energy cost for existing applications, to explore new applications, and to claim fresh water from new and contaminated sources, for an increasingly thirsty world.

A few major water treatment technologies and their applications, suitable source water, advantages and shortcomings are listed in Table 1. Among them, distillation has been used for centuries and even nowadays more than half of the total seawater desalination capacity is still based on it. In the past decades, most new seawater desalination plants were built upon reverse osmosis (RO) technology, because it is more energy efficient than distillation. However, only in large scale desalination plants, complicated pressure recovery system can be applied to reach the high energy efficiency. In brackish/surface/ground water purification and small scale desalination applications, electrodialysis (ED) and/or electrodialysis reversal (EDR) (which is relatively new development of ED) have been widely adopted due to its comparable or even better energy efficiency than RO in such applications, with additional benefits such as higher recovery ratio, low pressure and noise; and less fouling and pre-treatment requirement. However, unlike RO in which its membrane blocks most impurities including ions while allow only pure water passed through the membrane under high pressure to be collected, in ED system only part of charged ions migrated through its ion exchange membranes were removed from the output, results in less purified and relatively higher TDS (total dissolvable solid) output water. An electrochemical treatment process which can reach output purity even higher than RO is electro-deionization (EDI), also called continues electro-deionization (CEDI). EDI is a combination of ED and ion-exchange (IX) technologies. In traditional IX, regularly chemical (e.g. strong acid) regeneration of the IX resin is needed. While in EDI the resin is regenerated continuously by electricity thus it is safer, more environmental friendly than IX and need less maintenance. EDI is replacing IX in some applications such as deionized water for power plants, pharmaceutical process and microelectronics industry, but its adoption is still hindered by relatively high initial cost and low efficiency in the current stage.

TABLE 1
Comparison of Existing Water Purification Technologies

| | | | Cost- | |
|---|---|---|---|---|
| | | | effective | |
| | | | input TDS | |
| | Advantages | Disadvantages | (mg/L) | Applications |
| Distillation | Energy | Low energy efficiency. | 20,000-100,000 | Large scale seawater |
| | consumption | High maintenance cost. | | desalination |
| | independent of | | | |
| | salinity. | | | |
| | Using heat | | | |
| | directly. | | | |
| RO (Reverse | Comprehensive | Complicated pre- | 50-46,000 | Seawater/brackish |
| Osmosis) | removal of | treatment. | | water desalination. |
| | contaminant. | High pressure system. | | Pure water |
| | High energy | Noise. | | production. |
| | efficiency in | High maintenance cost. | | |
| | large scale. | Low recovery ratio. | | |
| | Wide TDS | Membrane fouling. | | |
| | input range | | | |
| ED/EDR | High recovery | Low salt removal ratio in | 200-3000* | Brackish |
| (Electrodialysis | ratio. | one stage (−50%). Low | | water/Small scale |
| Reversal) | Resistant to | removal of low-charged | | seawater |
| | Chlorine and | compounds and partials. | | desalination. |
| | fouling. | Higher power consumption | | Waste water |
| | Less pre- | for high TDS water. | | processing. |
| | treatment. | Higher output TDS. | | Food processing. |
| | | | | Salt concentration. |
| EDI/CEDI/IX | Ultrapure | Low TDS input required. | 1-800 | Ultrapure water for |
| (continues | output. | High cost. | | industries of power, |
| Electrodeionization/ | Ability to | | | pharmaceutical and |
| Ion exchange) | remove silica | | | microelectronics. |
| | and CO₂. | | | |

### BRIEF DESCRIPTION OF THE FIGURES

In the drawings:

FIG. 1 is an illustration showing a cross-sectional view of an embodiment of a device for performing polarized electrodialysis;

FIG. 2 is an illustration showing a cross-sectional view of another embodiment of a device for performing polarized electrodialysis;

FIG. 3 is an illustration showing a cross-sectional view of other embodiments of a device for performing polarized electrodialysis;

FIG. 4 is an illustration showing an expanded view of yet another embodiment of a device for performing polarized electrodialysis; and

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Some embodiments described herein generally relate to apparatus and methods for water purification by polarized electrodialysis (PED). As used herein, the term “polarized” in the context of electrodialysis (ED) may refer to (1) purification of water due to electrodialysis in addition to concentration polarization near an ion exchange membrane which creates an ion-depleted stream; and (2) different effective sizes of an anion exchange membrane (AEM) and a cation exchange membrane (CEM) that are polarized and, thus, lead to different current density levels of the AEM and CEM. As used herein and in the claims, the term “membrane” means a layer, barrier or material, which may or may not be permeable. Unless specified otherwise, membranes may take the form of a solid, liquid or gel, and may or may not have a distinct lattice or cross-linked structure. An “anion-exchange membrane” may refer to a membrane having functional groups that enable it to bind and release negatively charged ions. An anion-exchange membrane, thus, permits the passage of anions while substantially blocking the passage of cations. A “cation-exchange membrane” may refer to a membrane having functional groups that enable it to bind and release positively charged ions. A cation-exchange membrane may, thus, permits the passage cations while substantially blocking the passage of anions.

The PED technologies described herein provide distinct advantages and abilities for water treatment. A prototype device was fabricated and tested which verified that the PED device is able to desalt and purify water, remove or concentrate red dye, and can work in both forward and reverse polarity. In comparison to conventional ED technology, the PED technologies described herein provide less membrane usage, higher purity output, and the ability to treat larger and weakly charged matters other than ions. With its ability, PED may be suitable for many applications, for example, 1) demineralization of municipal, surface water, groundwater, and brackish water, which can be in large scale or small scale, e.g. household applications, water softener; 2) small scale seawater desalination, or large scale seawater desalination when footprint, weight, noise, mobility, maintenance and initial cost are major concerns; 3) production of high purity water for electronic, semiconductor, pharmaceutical industry and power plants; 4) wastewater treatment, such as removal or concentration of fluoride, heavy metals, textile dyes, and the like; and 5) removal/concentration of weakly charged or non-permeable matters, such as bio-medical samples. Thus, the PED technologies described herein may replace conventional ED, RO and/or EDI.

In some embodiments, apparatus for performing polarized electrodialysis may include a pair of electrodes, at least one cation exchange membrane and at least one anion exchange membrane disposed between and spaced apart from the electrode pair, a sample reservoir between the at least one cation exchange membrane and the anion exchange membrane, and a partition member disposed at least partially in the reservoir. In embodiments in which the apparatus includes multiple anion and cation exchange membranes, the anion and cation exchange membranes may alternate with one another. One of the cation exchange membrane and the anion exchange membrane may have a different size or effective area than the other to generate different current densities. For example, the membranes may be sized and configured such that one is working below a limiting current density while the other is working over a limiting current density. The membranes may each be disposed within a frame, and the frames may be disposed in horizontal alignment with the electrodes.

A sample solution including water and ions may be into a first reservoir formed between an anion exchange membrane and a cation exchange membrane. A rinse solution may be introduced into second reservoir(s) between a first electrode and the anion exchange membrane and between a second electrode and the cation exchange membrane. A voltage may be applied between the first and second electrodes to generate concentration polarization. As used herein, the term “concentration polarization” may refer to a concentration of ions near the surface of one of at least one of the cation and anion exchange membranes being substantially or significantly lower than a concentration of ions in the sample solution. Purified water from may be collected from a purified outlet stream that is separated from a non-purified outlet stream by a partition board between the anion exchange membrane and the cation exchange membrane.

The apparatus and methods described herein provide efficient water purification in comparison to conventional processes.

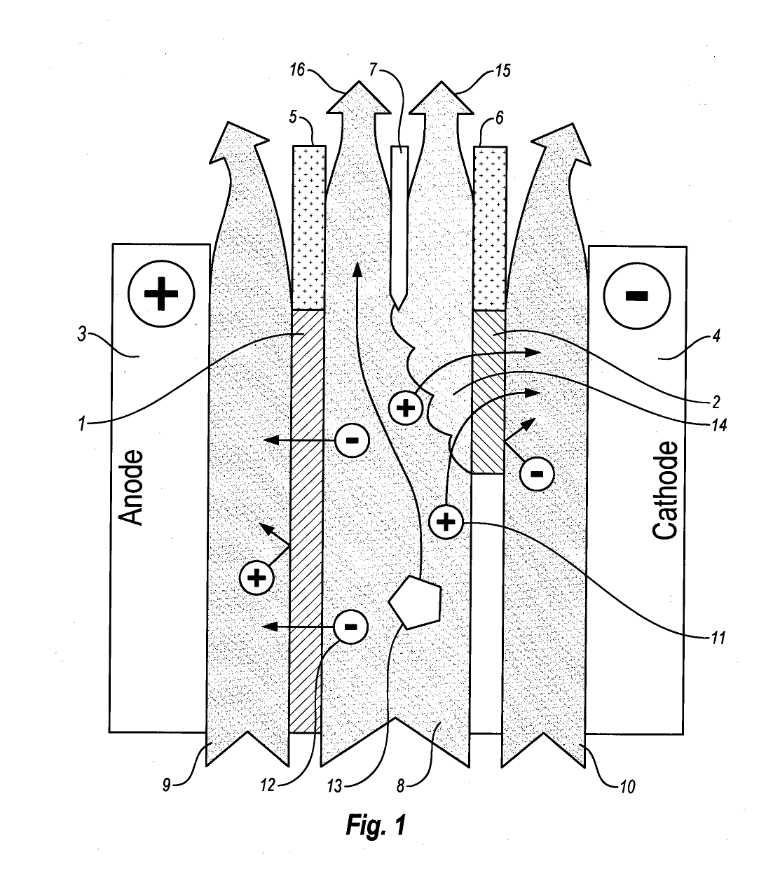

Referring to FIG. 1, an embodiment of a device for performing polarized electrodialysis is shown. An anion exchange membrane (AEM) 1 together with its frame 5, and a cation exchange membrane (CEM) 2 together with its frame 6, are disposed in between an anode 3 and a cathode 4. The AEM 1 and the CEM 2 may be collectively referred to herein as “the membranes.” The AEM 1 and CEM 2 have essentially different effective area size for ion exchange. A partition board 7 is disposed between the AEM complex (formed by the AEM 1 and its frame 5) and CEM complex containing the CEM 2 and its frame 6. During operation, a sample solution 8 flows in from a side of a gap between the AEM complex and the CEM complex. Meanwhile conductive anode rinsing solution 9 flows through the gap or chamber between anode 3 and AEM complex 1 and 5, while conductive cathode rinsing solution 10 flows through a gap or chamber between the cathode 4 and the CEM complex 2 and 6. The sample solution 8 may contain cations 11, anions 12, and other charged or weakly charged materials 13, which may be bigger in size than ions.

When there is a voltage applied between the electrodes 3 and 4, the cations 11 in the solutions 8, 9 and 10 are forced to move toward the cathode 4 while anions 12 in the solutions are forced to move toward the anode 3. Due to the semi-permeability of the AEM 1 and CEM 2, cations 11 in the sample solution 8 can migrate through the CEM 2 to reach the cathode rinsing solution 10 and anions 12 in the sample solution 8 can migrate through the AEM 1 to reach the anode rinsing solution 9, while both migration of anions from cathode rinsing solution 10 to the sample solution 8 and migration of cations from anode rinsing solution 9 to the sample solution 8 are blocked. Thus, the electrical current removes both the anions 12 and the cations 11 in the sample solution 8 that the salt concentration in the sample solution 8 is reduced in the process.

The above ion removal from sample solution 8 is the principle of electrodialysis (ED) desalination. However more interestingly, in the PED device, because the AEM 1 and CEM 2 are essentially different in effective area for ion exchange, for the same electrical current level through both the AEM 1 and the CEM 2, the current densities through the AEM 1 and the CEM 2 are different. For example, in the embodiment illustrated in FIG. 1, the effective area of CEM 2 is essentially smaller than AEM 1, thus the current density through the CEM 2 is essentially higher than that through the AEM 1.

Adjusting the current across the device, the current density through the CEM 2 can be higher than a so-called limiting current density, while still keeping the current density through the AEM 1 below the limiting current density. When the CEM 2 is working at over limiting current density, a phenomenon called concentration polarization happens which means the ion concentration near the surface of the CEM 2 is lower than the ion concentration in the bulk liquid of the sample solution. When current density increases, ions in a solution migrate through the membrane faster than they move through the solution, causing depletion of ions in the solution near the membrane, or in other words, forming an ion depletion region 14 in which the water is purified near the CEM 2. The partition board 7 downstream from the ion depletion region 14 split the sample solution 8 into two output streams. The stream between the partition board 7 and CEM frame 6 is essentially the liquid from the ion depletion region, which forms a purified output 15. For example, the purified output 15 may be substantially free of ions (cations 11 and anions 11) and the larger materials 13. While the stream on the other side of the partition board 7 (i.e., the stream between the partition board 7 and the anion exchange membrane 1) forms a non-purified output 16. The non-purified output 16 may contain nearly all the ions (cations 11 and anions 11) that remained in the sample solution 8 after those removed by the current through the membranes. In addition, weakly charge ions and/or larger materials 13 which cannot migrate through the membranes are collected or concentrated in this non-purified output 16 stream.

While the AEM 1 may be larger in size, area or dimensions in comparison to the CEM 2, as shown in FIG. 1, it is to be understood that the AEM 1 may be smaller than the CEM 2. In embodiments in which the CEM 2 is larger than the AEM 1, the ion-depletion region will be near the surface of the CEM 2.

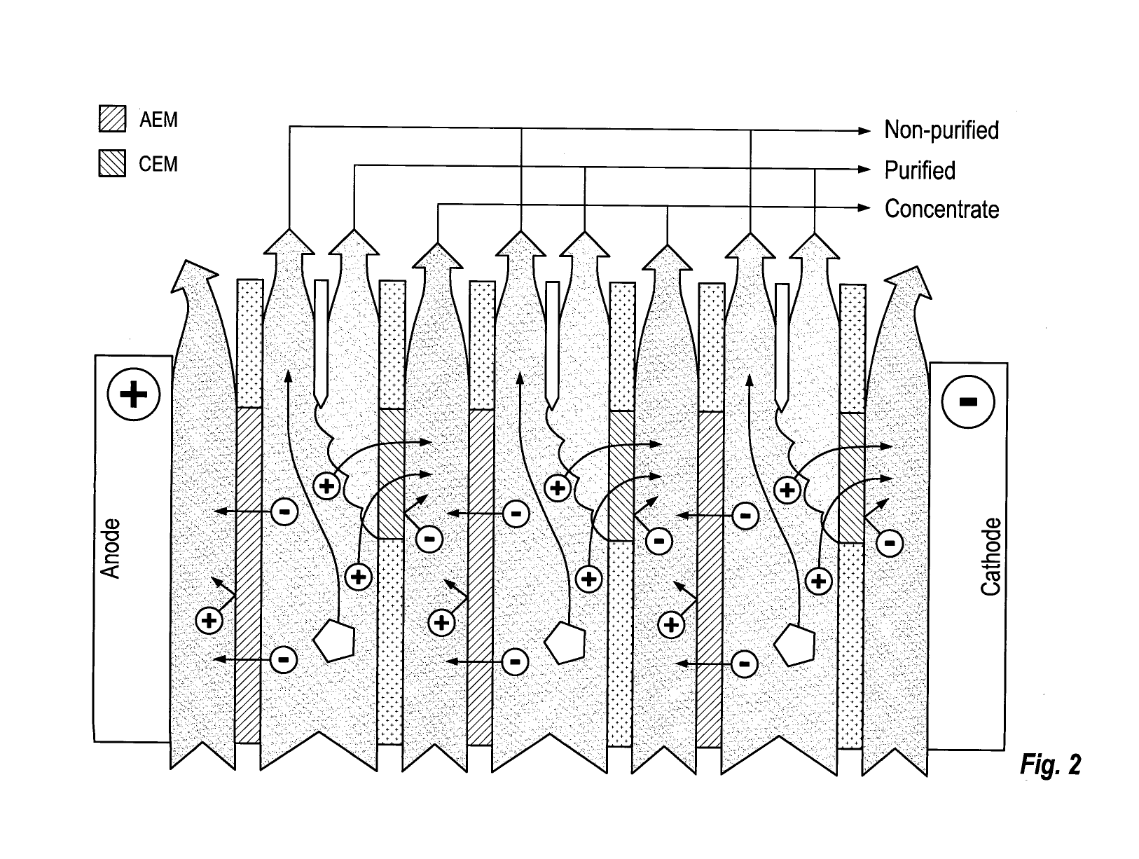

Referring to FIG. 2, more than one AEM and CEM can be alternately stacked in between electrodes (i.e., the anode and cathode) to increase the output flow rate and reduce energy consumption. FIG. 2 illustrates a PED configuration which contains three (3) AEM and CEM pairs. Solution streams flowing in between the membrane pairs collect the ions migrated through the membranes and form the concentrate output. Tens of or even hundreds of pairs of membranes can be stacked this way. Because all the pairs of membranes share one electrode pair, the energy wasted on the electrode reactions are minimized. In addition, gases, acid, alkaline and other contaminants generated at the electrode reactions are restricted in the two electrode rinsing streams.

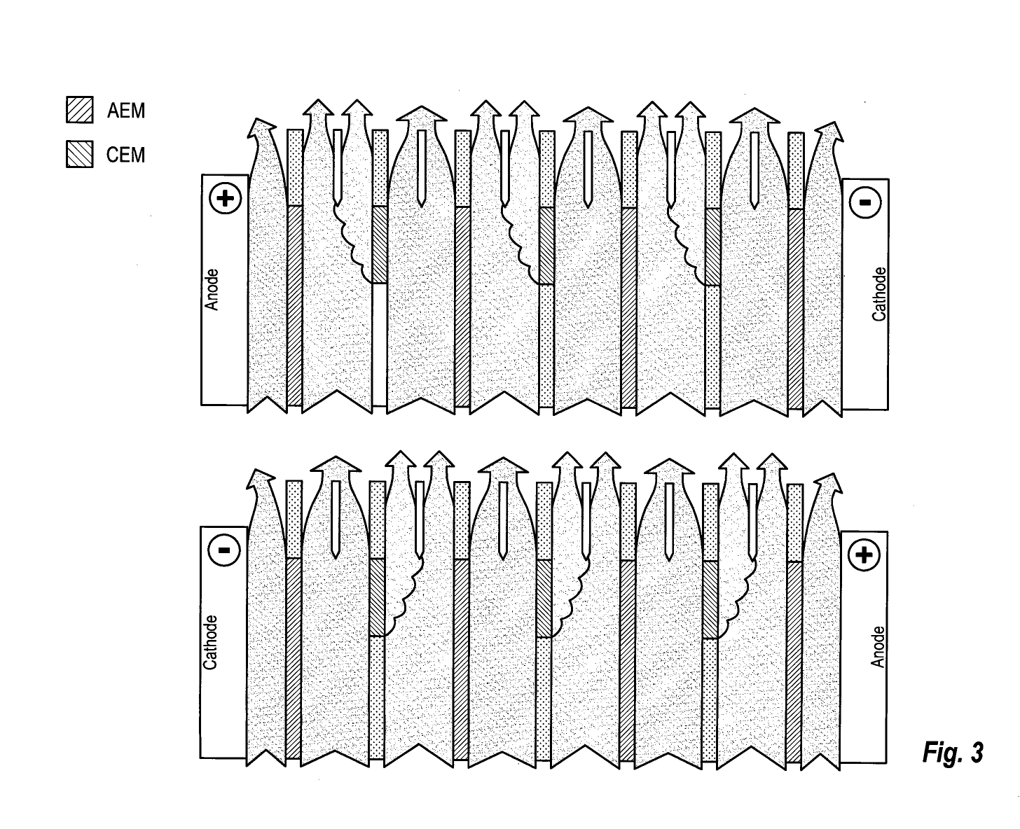

Referring to FIG. 3, an embodiment of a device for performing polarized electrodialysis is shown. As shown in FIG. 3, the device for performing polarized electrodialysis may be configured for performing polarized electrodialysis reversal (PEDR). As used herein, the term “polarized electrodialysis reversal” may refer to a process in which the polarity of the electrodes can be reversed frequently; while maintaining continuous purification outputs with control of inlet/outlet valves. Some benefits of the reversal include: reduce/eliminate fouling of electrodes, reduce/eliminate fouling of membranes, and reduce/eliminate scale on membranes due to water hardness (divalent ions such as Ca2+, Mg2+). FIG. 3 illustrates a PEDR device and how it works with both forward and reversed polarities of the electrodes. In the PEDR device, there are partition boards between each of any two membranes. Half of the partition boards functions to separate purified and non-purified output streams when the electrodes are with one polarity, while the other half of the partition boards functions when the polarity of electrodes is reversed.

In comparison with electrodialysis in which both the AEM and CEM are similar in size and working below limiting current density, in polarized electrodialysis, the AEM and CEM are significantly different in size, and one is working below limiting current density while the other is working over limiting current density. The apparatus described herein a partition board inside the gap between the AEM and CEM pair for separation of water in the ion depletion region from the rest of the stream in the gap.

The apparatus described herein enable removal/concentration of less-charged and larger ions, organics and particles (e.g., blood cells, proteins, and the like), which cannot be removed by ED. In addition, the PED performed by the apparatus provides a higher purity output than ED and a higher current density than ED. Thus, the apparatus enables PED to be performed using less membrane, which results in less weight, size, and cost.

### Examples

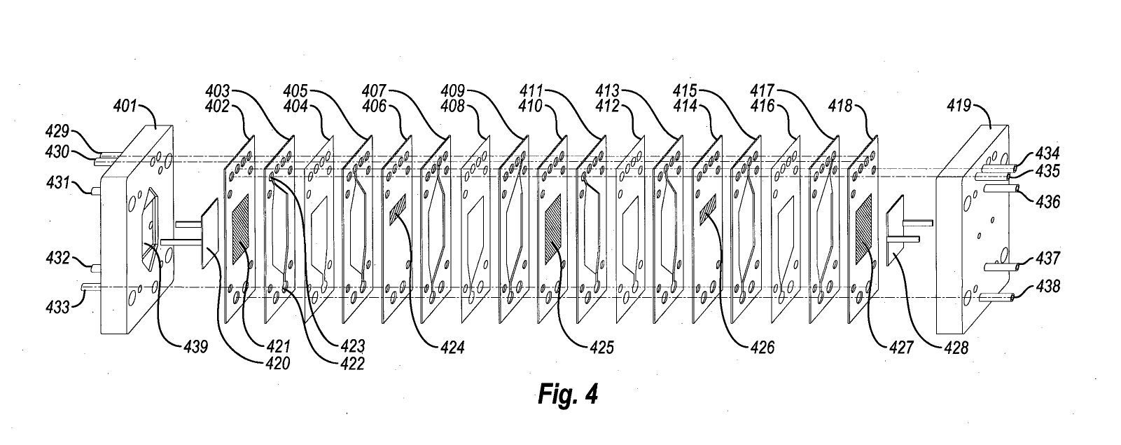

A prototype apparatus 400 for performing PED was designed and tested to verify the PED/PEDR concept. FIG. 4 illustrates an exploded view of the design of the apparatus 400. There are two end plates 401 and 419. On each end plate there is an electrode chamber 439 and multiple inlets/outlets on first end plate 401 (e.g., 429 to 433). A first electrode 420 is fitted in the electrode chamber 439 on the first end plate 401. The apparatus 400 includes two CEMs 424 and 426 and three AEMs 421, 425 and 427, each of which is embedded a frame to form membrane complexes 402, 406, 410, 414, and 418. Between the membrane complexes there are spacers 403, 405, 407, 409, 411, 413, 415, and 417, and partition boards 404, 408, 412, and 416. The spacers not only create gaps between membranes but also have channels to guide liquid flow from proper inlets to proper outlets. For example, the spacer 403 has channels 422 and 423 which guide sample solution coming from the inlet 433 to the outlet 435, while the channels on the spacer 407 guide solution coming from the inlet 438 to the outlet 430. The dimensions of the end plates are 36 mm×60 mm×10 mm (width×height×thickness). The membrane complexes and spacers have dimensions of 22 mm×59 mm×0.5 mm (width×height×thickness). The partition boards have dimensions of 22 mm×59 mm×0.25 mm (width×height×thickness). A rinsing solution coming from inlet 432 flows through the electrode chamber 439 between the first electrode 420 and the adjacent AEM membrane 421, and then flows out through the outlet 431. The same happens to the second electrode 428, the second end plate it attached to, the electrode rinsing inlet 437 and outlet 436m and the adjacent membrane 427.

The end plates 401 and 419 were made from a 10 mm thick acrylic board, cut and engraved by a carbon dioxide (CO₂) laser engraver. The electrodes 420 and 428 were made of 0.5 mm titanium sheet coated with 1 μm thickness platinum, scissor cut and bond to the respective end plates 401 and 419 using silicone glue. The inlets and outlets 429 to 433 were made from 2.5 mm OD plastic tubing, glued to the end plates. The membrane frames are made from 0.5 mm thick silicone rubber sheets, cut by the laser. AEM and CEM sheets (commercially available from Hangzhou Iontech Environmental Technology Co., Ltd. El.) were knife cut to suitable pieces and embedded into the membrane frames. Laser cut pieces of adhesive tape were applied on both sides of the membrane frames to fit the membranes with them, to form the membrane complexes 402, 406, 410, 414, and 418. The spacers 403, 405, 407, 409, 411, 413, 415, and 417 were made by laser cutting of 0.5 mm silicone rubber sheets, and the partition boards 404, 408, 412, and 416 were made by laser cutting 0.25 mm polycarbonate sheets. All the components are aligned by four positioning poles secured using four plastic pins. Then the components were assembled and compressed to air tight by four M5 bolts and nuts.

Test of a PEDR Prototype

The apparatus 400 was tested as a PEDR concept using a sample solution containing 10 mM of NaCl, and about 0.2% of printer red ink which rendered the sample a red color. Besides the sample solution, other liquid input of the device including anode rinsing, cathode rinsing, and concentrate input were 10 mM NaCl solution. The flow rates of the solutions in the apparatus were controlled by two peristaltic pumps. One pump with two channels controls the flow of anode rinsing and cathode rinsing solution. The other pump which has four channels controls the flow from four outlets. In the current stage the device has been tested in three aspects. Firstly the ability to desalt or purify water, secondly the ability to remove or concentrate larger matters such as the red dye in the solution which cannot be removed by ED devices, and lastly the functionality of the reversal configuration.

Desalination & Purification

In one experiment, a voltage of 35 V was applied on the electrodes. The first electrode 420 acted as an anode and the second electrode 428 as the cathode. Sample solution was pulled into the device through the lower inlet 433 on the first end plate 401, and out the device through the two outlets 434 and 435 on the second end plate 419. Concentrate solution was pulled into the device through the lower inlet 438 on the second end plate 419, and out the device through the two outlets 429 and 430 on the first end plate 401. Meanwhile, electrode rinsing solutions were passing through the electrode chambers. At a flow rate of 0.3 ml/min for the concentrate solution output, and 0.15 ml/min for both the purified output and the non-purified output, the electrical current was observed to be 6.2 mA. The purified output from outlet 434 was measured to have a conductivity of 153 μs/cm, which indicates an 87% removal of salt in one pass from its input conductivity of 1185 μs/cm. The conductivity of the purified output is also much lower than the conductivity of the non-purified output from outlet 435 which was measured to be 670 μs/cm. This difference indicated the effectiveness of the concentration polarization. The conductivity of the non-purified output is lower than the input, which is the effect of electrodialysis.

Red Dye Removal and Concentration

In the above experiment, it was also observed that the purified output stream from outlet 434 was clear without red color, while the non-purified output from outlet 435 was still red. The clear color of the purified output indicated that the red dye was removed from this stream. Since the red dye cannot migrate through the membranes, the red dye removed from the purified output stream was concentrated in the non-purified output stream.

Reversal Functionality

In another experiment, the polarity of the electrodes was reversed, the first electrode 420 acted as cathode and the second electrode 428 as the anode. Sample solution was pulled into the device through the lower inlet 438 on the second end plate 419, and out the device through the two outlets 429 and 430 on the first end plate 401. Concentrate solution was pulled into the device through the lower inlet 433 on the first end plate 401, and out the device through the two outlets 434 and 435 on the second end plate 419. The same voltage level and flow rate was applied as the previous experiment and we observed similar current level, desalination and dye removal and concentration, demonstrating that the apparatus 400 is functional in both forward and reversal modes.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions or biological systems, which can, of course, vary. It is also to be understood that the terminology used herein is for the purpose of describing particular embodiments only, and is not intended to be limiting.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An apparatus for performing polarized electrodialysis, comprising:
at least a pair of electrodes;
at least one cation exchange membrane and at least one anion exchange membrane disposed between and spaced apart from the electrode pair;
a sample reservoir between the at least one cation exchange membrane and the anion exchange membrane;
at least a partition member disposed at least partially in the reservoir.

2. The apparatus of claim 1, wherein the at least one cation exchange membrane is smaller than the at least one anion exchange membrane.

3. The apparatus of claim 1, wherein the at least one anion exchange membrane is smaller than the at least one cation exchange membrane.

4. The apparatus of claim 1, wherein the at least one cation exchange membrane has a smaller or larger effective surface area than the at least one anion exchange membrane.

5. The apparatus of claim 1, wherein the at least one cation exchange membrane and the at least one anion exchange membrane are disposed within a frame.

6. The apparatus of claim 1, further comprising first rinsing solution reservoir between a first electrode of the electrode pair and the anion exchange membrane and second rinsing solution reservoir between a second electrode of the electrode pair and the cation exchange membrane.

7. An apparatus for performing polarized electrodialysis, comprising:
at least a pair of electrodes;
a plurality of ion exchange membranes disposed between the pair of electrodes and comprising cation exchange membranes alternating with anion exchange membranes; and
a reservoir between each of the electrodes and the ion exchange membranes.
at least a partition is disposed in at least a portion of each of the reservoirs between one of the anion exchange membranes and one of the cation exchange membranes.

8. The apparatus of claim 7, wherein a first electrode of the pair of electrodes is disposed adjacent one of the anion exchange membranes and a second electrode of the pair of electrodes is disposed adjacent one of the cation exchange membranes.

9. The apparatus of claim 7, wherein each of the electrodes is disposed adjacent one of the anion exchange membranes.

10. The apparatus of claim 7, wherein each of the electrodes is disposed adjacent one of the cation exchange membranes.

11. The apparatus of claim 9, wherein the apparatus is configured to perform reversed polarized electrodialysis.

12. The apparatus of claim 7, wherein the anion exchange membranes and the cation exchange membranes have different effective sizes designed to generate different current density levels.

13. The apparatus of claim 7, wherein the pair of electrodes and the plurality of ion exchange membranes are longitudinally aligned with one another.

14. The apparatus of claim 7, wherein the cation exchange membrane conducts cations and the anion exchange membrane conducts anions.

15. A method for purifying water, comprising:
introducing a sample solution including water and ions into a first reservoir formed between an anion exchange membrane and a cation exchange membrane;
introducing rinse solution into a second reservoir between a first electrode and the anion exchange membrane and into a third reservoir between a second electrode and the cation exchange membrane;
applying a voltage between the first and second electrodes to generate concentration polarization wherein concentration of ions near the surface of one of at least one of the cation and anion exchange membranes is lower than a concentration of ions in the sample solution; and
collecting purified water from a purified outlet stream, and/or sample from a non-purified outlet stream.

16. The method of claim 15, further comprising splitting the sample solution into the purified outlet steam and a non-purified outlet stream using a partition disposed in at least a portion of the first reservoir.

17. The method of claim 16, wherein applying a voltage comprises adjusting current across between the electrodes such that the current density through the cation exchange membrane is greater than a limiting current density and the current density through the anion exchange membrane is below the limiting current density.

18. A method for purifying water, comprising:
applying a voltage between a first electrode and a second electrode to generate an ion depletion region proximate at least one of a plurality of ion exchange membranes disposed between the first and second electrodes, wherein the plurality of ion selective membranes include at least one cation exchange membrane and at least one anion exchange membrane, such cations and anions in a sample solution are respectively passed through the at least one cation exchange membrane and at least one anion exchange membrane into reservoirs; and
separating the sample stream into a purified water stream and a rion-purified output stream.

19. The method of claim 18, wherein the sample stream is separated into the purified water stream and the non-purified output stream by a partition in a sample reservoir between the at least one cation exchange membrane and at least one anion exchange membrane.
